(19) United States
(12) Patent Application Publication
(10) Pub. No.: US 2012/0115343 A1
(43) Pub. Date: May 10, 2012

(54) HOSPITAL GRADE RECEPTACLE ASSEMBLY

(76) Inventor: Bradley Plattner, Kendallville, IN (US)

(21) Appl. No.: 12/942,795

(22) Filed: Nov. 9, 2010

(51) Int. Cl. H01R 4/60

(52) U.S. Cl. 439/214

(57) ABSTRACT

The invention comprises, in one form thereof, a modular wiring system for use in a hospital environment including an electrical receptacle connectable to an electrical power supplying connector. The electrical receptacle includes a faceplate and a plurality of terminals. The faceplate has a plurality of openings therein. The plurality of terminals are each associated with a corresponding opening in the face plate. The plurality of terminals include a blade receiving terminal configured to substantially stabilize a blade of a plug inserted therein and prevent a withdrawal of the blade when up to three pounds of force is applied to the plug in a direction substantially perpendicular to the blade and the blade receiving terminal.

### BACKGROUND OF THE INVENTION

1. Field of the Invention

The present invention relates to modular wiring system, and, more particularly, to an electrical receptacle utilized in a modular wiring system for use in a hospital environment.

2. Description of the Related Art

Modular wall panel systems are used extensively in commercial and industrial settings to define work space, provide privacy, control traffic flow, and minimize noise. Wall panel systems can be provided with suitable structures such as desks, tables, shelves, trays, and the like as well as utilized with other furniture or medical room components. In addition, wall panel systems can be advantageously utilized in hospital environments.

Wall panel systems may include a modular wiring system that would utilize receptacles. The wall panel systems may be those described in U.S. Pat. No. 7,303,417. Modular wiring systems can be used in wall panel systems or in other applications where modular wiring is used to meet specific goals such as modularity, ease of repair and ease of maintenance.

Modular wiring systems are essential to provide electrical power to work stations located in and around the hospital environment, such as in a patient room. The demands for electrical power may require the provision of several circuits throughout the wiring system. Accordingly, it is desirable that an electrical distribution system be provided with a modular wiring system that is easy to install, yet provides a high level of electrical service and is reconfigurable.

What is needed in the art is a modular receptacle that is easily connected to a modular wiring system for use in a hospital environment.

### SUMMARY OF THE INVENTION

The present invention provides a modular electrical receptacle for use in a hospital environment.

The invention comprises, in one form thereof, a modular wiring system for use in a hospital environment including an electrical receptacle connectable to an electrical power supplying connector. The electrical receptacle includes a faceplate and a plurality of terminals. The faceplate has a plurality of openings therein. The plurality of terminals are each associated with a corresponding opening in the face plate. The plurality of terminals include a blade receiving terminal configured to substantially stabilize a blade of a plug inserted therein and prevent a withdrawal of the blade when up to three pounds of force is applied to the plug in a direction substantially perpendicular to the blade and the blade receiving terminal.

The invention comprises, in another form thereof, an electrical receptacle for use with a modular wiring system in a hospital environment. The receptacle includes a faceplate, at least one electrical conductor, and a blade receiving terminal. The faceplate has a plurality of openings therein. The at least one electrical conductor has connecting feature directed in a direction substantially parallel with said faceplate. The electrical conductor is formed from a conductive metal having a first thickness. The blade receiving terminal is formed from a conductive metal having a second thickness. The electrical conductor is electrically connected to the blade receiving terminal. The first thickness is less than the second thickness.

The invention comprises, in yet another form thereof, an electrical receptacle for use with a modular wiring system in a hospital environment. The receptacle includes a housing and a blade receiving terminal. The housing has a faceplate connected thereto. The faceplate has a plurality of openings therein. The blade receiving terminal is formed from a conductive metal. The blade receiving terminal is aligned with one of the openings and is configured to receive a blade of an electrical plug. The blade receiving terminal includes a U-shaped portion when viewed in a direction in which the blade is inserted into the blade receiving terminal. The blade receiving terminal has at least two fingers that extend from the U-shaped portion. The at least two fingers have a predetermined distance therebetween. The predetermined distance remains substantially unchanged when a blade of an electrical plus is inserted between the at least two fingers.

An advantage of the present invention is that the blade receiving terminal is made of a heavier material than the conductor providing power thereto.

Another advantage of the present invention is that the U-shaped portion is a substantial length as compared to the overall length of the blade receiving terminal, thereby strengthening the overall structure.

Yet another advantage of the present invention is that it is configured to prevent the withdrawal of the blade inserted into the blade receiving terminal when a force of up to three pounds is applied perpendicular to the blade.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is perspective view of a modular wiring system and, more specifically, an embodiment of an electrical receptacle of the present invention;

FIG. 2 is an exploded perspective view of the receptacle of FIG. 1;

FIG. 3 is a perspective view of a terminal and a conductor utilized in the receptacle of FIGS. 1 and 2;

FIG. 4 is a partially sectioned view of a blade receiving terminal utilized in the receptacle of FIGS. 1 and 2;

FIG. 5 is plane view of the blade receiving terminal of FIGS. 2 and 4; and

FIG. 6 is a side view of the blade receiving terminal of FIGS. 2, 4 and 5.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

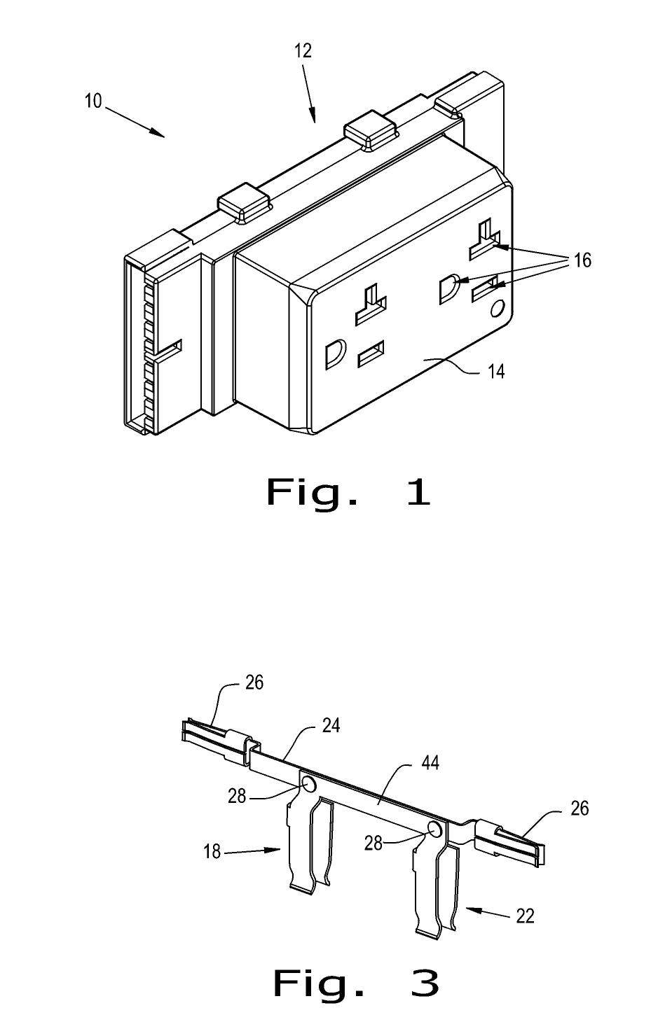

Referring now to the drawings, and more particularly to FIG. 1, there is shown a modular wiring system 10 and, more particularly, an electrical receptacle 12, having a face 14 also known as a faceplate 14 with openings 16 therethrough. Electrical receptacle 12 is configured to be electrically connected to a power supplying connector (not shown).

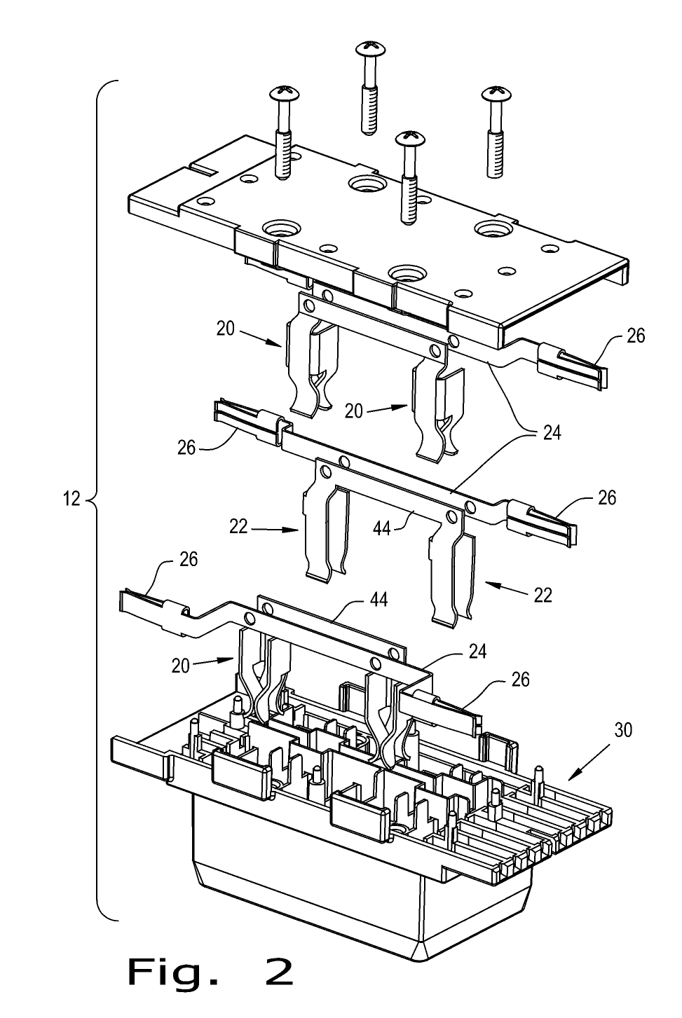

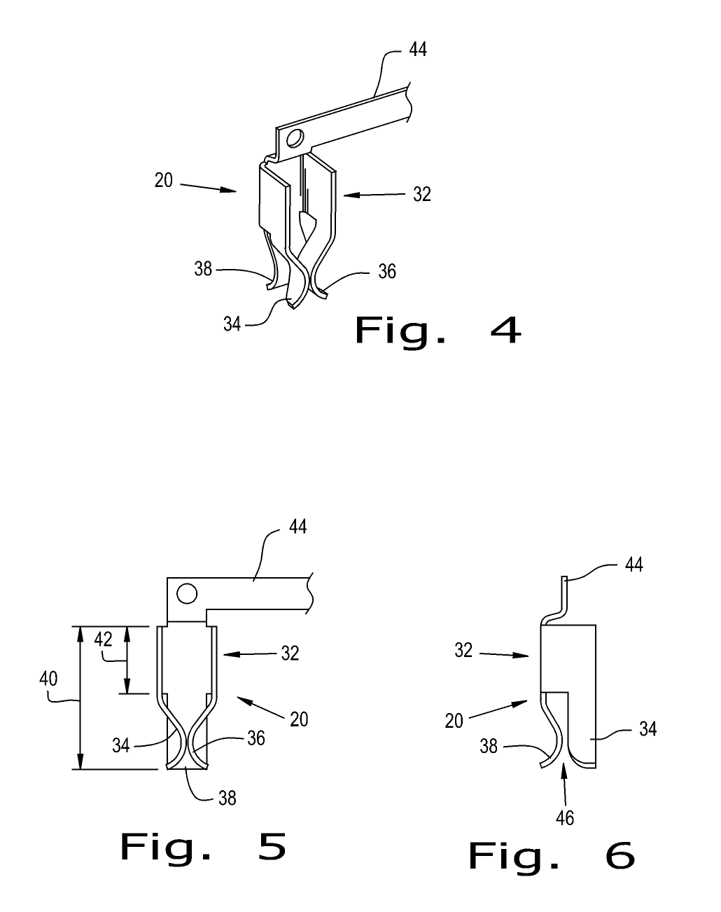

Now, additionally referring to FIGS. 2-6, there is illustrated an electrical receptacle 12 having terminals 18 inserted therein. Terminals 18 include blade receiving terminals 20 and ground receiving terminal 22. Electrical conductors 24 having connecting features 26 and are connected to terminals 18 by way of rivets 28. Cavities 30 in the housing toward the end of the housing of receptacle 12, are configured for receiving connecting features 26 therein.

Terminals 18 and, more particularly, blade receiving terminal 20 has a U-shaped portion 32 with fingers 34, 36, and 38 extending therefrom. Blade receiving terminal 20 has an overall length 40 and U-shaped portion 32 has a length 42. Terminals 18 have a flat portion 44 that corresponds to a flat portion of electrical conductors 24. It is along the mutual flat portions of each that rivets 28 are utilized to connect the two together. Fingers 34 and 36 coact with finger 38 to define a predetermined distance 46 between finger 38 and fingers 34 and 36.

Although electrical conductors 24 are illustrated as being joined to terminals 18 by way of rivets 28, other attachment methods are contemplated. For example, terminal 18 can be connected to electrical conductor 24 by riveting, welding and/or press fitting. Welding can be done using ultrasonic, thermal or resistive welding techniques. Press fitting is meant to include the processes of TOX® that displaces material causing an interlocking joint.

Conductors 24 and terminals 18 are each formed from flat conductive metal sheets that are bent into the form shown in the figures. Conductors 24 have connecting features 26 that are folded from the original flat piece of material. In a corresponding manner, terminals 18 are folded from a single electrical conductor sheet that has been stamped from a flat conductive material. The thickness of terminals 18 is thicker than the thickness of electrical conductors 24. Electrical conductors 24 are folded to form connecting features 26, which are placed into cavities 30. If connecting features 26 were made of a thicker material they would be too thick to populate cavities 30 and the density of electrical connections along an end of the housing that are utilized in the industry could not be maintained if the material utilized in terminals 18 was used to form conductors 24.

When receptacle 12 as shown in FIG. 1 has an electrical plug inserted into openings 16, blade receiving terminal 20 is configured to hold the plug in electrical contact therewith when a force up to three pounds is applied perpendicular to the direction of insertion of the plug into openings 16 and blade receiving terminal 20.

Length 42 of U-shaped portion 32 is a significant portion of overall length 40. Length 42 may be at least 40% of length 40 or even at least 50% of length 40. This extended length 42 of U-shaped portion 32 provides for increased strength in fingers 34, 36, and 38. When a blade of an electrical plug is inserted into predetermined distance 46 or gap 46, the strength of fingers 34, 36, and 38 are such that minimal movement, particularly of finger 38, occurs. Predetermined distance 46 is in a range of approximately 0.005 to 0.060 inches and may in particular be approximately 0.060 inch. Ranges for predetermined distance 46 may be different for different amp capacity receptacles. For example, the range for a 15 amp receptacle is approximately 0.045 to 0.060 inches, and the range for a 20 amp receptacle is approximately 0.005 to 0.030 inches.

The insertion of the blade into gap 46 is selected so that the distance between finger 38 and the combination of fingers 34 and 36 remains substantially unchanged when a blade of the electrical plug is inserted therebetween. Although the thickness of the flat material used to form the blade receiving terminals 20 and conductors 24 are of different thicknesses, the thickness of the flat material utilized to form blade receiving terminals 20 may be 0.035 inch and the thickness of conductors 24 may be 0.025 inch. This allows the geometrical constraints of the housing and, more particularly, cavities 30, to be unchanged from industrial standards utilized in the industry and allows the additional strength in blade receiving terminals 20 to meet hospital environment requirements. The thickness of blade receiving terminals 20 minimizes any flexing thereof but does allow for a relief area due to the predetermined width of gap 46 to allow for pull out of a blade when an appropriate retraction force is applied to the electrical plug in a direction substantially perpendicular with the surface of faceplate 14.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A modular wiring system for use in a hospital environment, comprising:
an electrical receptacle connectable to an electrical power supplying connector, said electrical receptacle including:
a faceplate having a plurality of openings therein; and
a plurality of terminals each associated with a corresponding one of said openings, said plurality of terminals including a blade receiving terminal configured to substantially stabilize a blade of a plug inserted therein and prevent a withdrawal of the blade when up to three pounds of force is applied to the plug in a direction substantially perpendicular to the blade and said blade receiving terminal.

2. The modular wiring system of claim 1, wherein said electrical receptacle further includes at least one electrical conductor having a connecting feature directed in a direction substantially parallel with said faceplate, said electrical conductor being formed from a conductive metal having a first thickness, said blade receiving terminal formed from a conductive metal having a second thickness, said blade receiving terminal configured to receive the blade through one of said openings, said electrical conductor being electrically connected to said blade receiving terminal, said first thickness being less than said second thickness.

3. The modular wiring system of claim 2, wherein said electrical conductor and said blade receiving terminal are connected along mutually flat portions of both said electrical conductor and said blade receiving terminal.

4. The modular wiring system of claim 3, wherein said blade receiving terminal is connected to said electrical conductor by at least one of riveting, welding and press fitting.

5. An electrical receptacle for use with a modular wiring system in a hospital environment, the receptacle comprising:
a faceplate having a plurality of openings therein;
at least one electrical conductor having a connecting feature directed in a direction substantially parallel with said faceplate, said electrical conductor being formed from a conductive metal having a first thickness; and
a blade receiving terminal formed from a conductive metal having a second thickness, said blade receiving terminal configured to receive a blade of an electrical plug through one of said openings, said electrical conductor being electrically connected to said blade receiving terminal, said first thickness being less than said second thickness.

6. The electrical receptacle of claim 5, wherein said electrical conductor and said blade receiving terminal are connected along mutually flat portions of both said electrical conductor and said blade receiving terminal.

7. The electrical receptacle of claim 6, wherein said blade receiving terminal is connected to said electrical conductor by at least one of riveting, welding and press fitting.

8. The electrical receptacle of claim 7, wherein said at least one electrical conductor is a plurality of electrical conductors, said electrical conductors being such that if said electrical conductors were made of material of said second thickness said connecting features would be too large for said electrical receptacle to accommodate said connecting features of said plurality of electrical conductors.

9. The electrical receptacle of claim 5, wherein said blade receiving terminal has an overall length, said blade receiving terminal having a U-shaped portion when viewed in a direction in which a blade is inserted into said blade receiving terminal, said U-shaped portion has a length that is at least 40% of said overall length.

10. The electrical receptacle of claim 9, wherein said length of said U-shaped portion is at least 50% of said overall length.

11. The electrical receptacle of claim 5, wherein said blade receiving terminal includes a U-shaped portion when viewed in a direction in which a blade is inserted into said blade receiving terminal, said blade receiving terminal having at least two fingers that extend from said U-shaped portion, said at least two fingers having a predetermined distance therebetween, said predetermined distance remaining substantially unchanged when a blade of an electrical plug is inserted between said at least two fingers.

12. The electrical receptacle of claim 11, wherein said at least two fingers is three fingers, said predetermined distance being between two of said three fingers and said other finger.

13. An electrical receptacle for use with a modular wiring system in a hospital environment, the receptacle comprising: a housing having a faceplate connected thereto, said faceplate having a plurality of openings therein; and
a blade receiving terminal formed from a conductive metal, said blade receiving terminal being aligned with one of said openings and being configured to receive a blade of an electrical plug, said blade receiving terminal includes a U-shaped portion when viewed in a direction in which the blade is inserted into said blade receiving terminal, said blade receiving terminal having at least two fingers that extend from said U-shaped portion, said at least two fingers having a predetermined distance therebetween, said predetermined distance remaining substantially unchanged when a blade of an electrical plug is inserted between said at least two fingers.

14. The electrical receptacle of claim 13, wherein said blade receiving terminal has an overall length, said U-shaped portion having a length that is at least 40% of said overall length.

15. The electrical receptacle of claim 14, wherein said length of said U-shaped portion is at least 50% of said overall length.

16. The electrical receptacle of claim 13, wherein said at least two fingers is three fingers, said predetermined distance being between two of said three fingers and the remaining finger.

17. The electrical receptacle of claim 13, further comprising at least one electrical conductor having a connecting feature directed in a direction substantially parallel with said faceplate, said electrical conductor being formed from a conductive metal having a first thickness, said blade receiving terminal formed from a conductive metal having a second thickness, said electrical conductor being electrically connected to said blade receiving terminal, said first thickness being less than said second thickness.

18. The electrical receptacle of claim 17, wherein said electrical conductor and said blade receiving terminal are connected along mutually flat portions of both said electrical conductor and said blade receiving terminal.

19. The electrical receptacle of claim 18, further comprising at least one rivet connecting said blade receiving terminal to said electrical conductor.

20. The electrical receptacle of claim 19, wherein said at least one electrical conductor is a plurality of electrical conductors, said electrical conductors being such that if said electrical conductors were made of material of said second thickness said connecting features would be too large for said electrical receptacle to accommodate said connecting features of said plurality of electrical conductors.
